(19) United States
(12) Patent Application Publication
(10) Pub. No.: US 2006/0027503 A1
(43) Pub. Date: Feb. 9, 2006

(54) Filtration media and method of preparation

(76) Inventor: Hal Alper, Flowery Branch, GA (US)

Correspondence Address: KLAUBER & JACKSON, 411 HACKENSACK AVENUE, HACKENSACK, NJ, 07601, US

(21) Appl. No.: 11/180,299

(22) Filed: Jul. 13, 2005

Related U.S. Application Data
(60) Provisional application No. 60/587,773, filed on Jul. 14, 2004.

(51) Int. Cl. C02F 1/28

(52) U.S. Cl. 210/692

(57) ABSTRACT

A method and apparatus for removing organic contaminants from an aqueous phase in which the contaminant is solubilized. In the method the aqueous phase is passed through a fluid-pervious filtration media which has been infused with an absorbtion composition comprising (1) a homogeneous thermal reaction product of an oil component selected from the group consisting of glycerides, fatty acids, alkenes, and alkynes, and a methacrylate or acrylate polymer component; and (2) a photoinitiator system; said absorbtion composition being cured in situ at the filter by exposure to actinic radiation. The contaminant is immobilized at said media, and the purified filtrate having passed through the filtration media is collected as the product.

### RELATED APPLICATIONS

This application claims priority from U.S. Provisional Application Ser. No. 60/587,773, filed Jul. 14, 2004, and is a continuation-in-part of my copending “nonprovisional” patent application, Ser. No. ______, filed Jul. 11, 2005.

### FIELD OF INVENTION

This invention relates generally to apparatus and methods for removing contaminants from aqueous systems, and more specifically relates to filtration devices and methods for removing slightly soluble and/or emulsified organic compounds (such as an oil-in-water emulsions) from such aqueous systems.

### BACKGROUND OF INVENTION

In recent years many previously clean water sources have been found to be contaminated with dispersed oils which are often present as oil-in-water emulsions. A further source of contamination arises from presence in the water of pernicious slightly soluble organic compounds such as benzene, toluene, xylene, halogenated hydrocarbons, ethoxylated glycols, etc. These noxious contaminants are among the more difficult compounds to remove from water, and indeed most are carcinogenic. In the present inventor's U.S. Pat. No. 6,180,010 it is disclosed that the compositions described in the inventor's U.S. Pat. Nos. 5,437,793; 5,698,139; and 5,837,146, and 5,961,823 (all of which disclosures are hereby incorporated by reference) have extremely strong affinities for the aforementioned contaminants in water; and that when aqueous streams containing these noxious contaminants are passed through filtration media incorporating these compositions, the contaminants are immobilized at the media, as a result of which concentration levels of the contaminants in the filtrate may be reduced to very low values.

Filter configurations incorporating the said compositions may be based on various water permeable substrates, such as shredded, spun or otherwise configured polypropylene or shredded or spun cellulose, which substrates are infused or otherwise treated with the absorbent compositions, which are then cured. These substrates may then be packed or otherwise disposed in a cartridge or canister filter; or can be formed into cured and infused bag filters which can be emplaced in canisters through which the contaminated water is flowed. Similarly the said compositions can be incorporated into or upon other filtering substrates and media, such as paper, including compressed pulp materials, particulate porous foamed plastics, mineral particulates such as perlite and vermiculite, and particulate, fibrous or porous ceramic or porous (e.g. sintered) metal substrates and media.

The term “absorbent composition” will be used herein as one of convenience for identifying the said compositions of my aforementioned patents, and will be used as well in referring to the new compositions of the present invention. The specific mechanism by which the noxious contaminants are removed from aqueous streams by conjunctive use of such “absorbent compositions” is not completely understood, and could include attachment and/or fixation of such contaminants by mechanisms which technically involve various physical and/or chemical interactions. The term “absorbent” as used herein is intended to encompass all of these possible mechanisms.

### SUMMARY OF INVENTION

Now in accordance with the present invention, a further filtration medium and method for its preparation has been found, which while incorporating certain components of the absorbent compositions of my prior patents, has unexpectedly been found to have markedly superior properties when used as such an absorbent composition in the filtration of organic contaminants from aqueous systems, as for example in removing oils from an oil-in-water emulsion.

The compositions of the present invention are prepared in part from the absorbent compositions of my prior art patents. These prior absorbents are the reaction product of an oil component and a methacrylate or acrylate polymer component. The absorbent compositions of the present invention are prepared by further combining such prior art reaction product (herein called “reaction product A”) with a photoinitiator system before infusing the combination into the fluid-pervious filtration media. Subsequent exposure of the infused filtration media to actinic UV radiation, effects a very rapid in situ curing of the infused composition, and results in a filter having markedly improved filtration characteristics. Although applicant is not bound by any specific theory, it is hypothesized that the UV in situ curing may result in extensive additional cross-linking of the infused absorbent, with consequent hardening of the infused composition, and pore sizes in the filtration media may in consequence be much smaller than in the filters of my prior methodology. Regardless of the precise mechanism involved, filters prepared by the present invention exhibit higher back pressure in use, with consequent increased dwell time for the aqueous streams being passed through the filter. The new filters are among other things found to be much more efficient in breaking oil-in-water emulsions than filters prepared by the inventor's prior methodology and compositions. For this reason, and for convenience, such filters shall be referred to herein as “EB” filters, and the corresponding infusion compositions shall at times be referred to as “EB” absorbent compositions. In contrast the filters prepared by the inventor's prior patented methodology and compositions shall, again for purposes of convenience, be referred to as “PA” filters and “PA” absorbent compositions.

In the general method for preparing an EB filter in accordance with the invention, a homogeneous thermal “reaction product A” is initially prepared from an oil component and a polymer component, as in my earlier cited patents. The thermal reaction product A here is preferably prepared in a temperature range of 350° to 550° F., and more preferably at a range of from about 400 to 500 deg. F. A photoinitiator system is separately prepared from a monomer cross-linking agent, a catalyst, and a wetting agent, i.e. an oligomer/adhesion promoter/cross-linking agent. An infusing solution is then prepared by combining the reaction product A and the photoinitiator system together with a solvent such as acetone. This solution is infused into the filtration media, e.g. a conventional filtration cartridge containing a filtration substrate such as fibrous polypropylene. The infused cartridge or other infused substrate is then exposed to UV radiation for a short period, usually of the order of several minutes to effect the desired curing. The EB filter is then ready for use.

### DESCRIPTION OF PREFERRED EMBODIMENTS

EB filter constructions utilizing the principles of the present invention can be based upon canisters, cartridges, or drums which are internally packed with filtration media comprising substrates such as mentioned above, which have been infused with or otherwise carry absorbent compositions in accordance with the invention, and wherein the infused materials are processed in accordance with the invention. Since the absorbent compositions of my earlier patents serve as the “reaction product A” as used in the present invention, it is appropriate here to describe these prior art products in some detail.

The absorbent composition thus disclosed in the first of my aforementioned patents, i.e. U.S. Pat. No. 5,437,793, is characterized therein as a coagulant product which comprises a glyceride such as linseed oil reacted with a polymer such as poly (isobutyl methacrylate) which is then diluted with a solvent, such as 2,2,4-trimethyl-1, 3-pentanediol monoisobutyrate. The composition formed by the thermal reaction of the linseed oil with the isobutyl methacrylate polymer is a soft resinous product which, when diluted with a solvent, results in a mixture that in the teaching of the said patent can be sprayed onto an oil spill or otherwise introduced to the oil spill to coagulate the oil. Additionally, however, and as disclosed in my further U.S. Pat. No. 5,698,139 patent and additional patents cited, further experimentation led to the discovery of additional absorbent compositions produced from polymers and a variety of natural animal and vegetable oils, fatty acids, alkenes and alkynes, which absorbent compositions are all utilizable in preparing the filters of the present invention. More generally these latter compositions are the thermal reaction product of a polymer component with an oil component selected from the group consisting of glycerides, fatty acids, alkenes and alkynes. The reaction conditions can be adjusted to provide a “first endpoint” product or a “second endpoint” product. Preferred compositions are disclosed which comprise the thermal reaction products of methacrylate polymers with a glyceride derived from a variety of natural animal and vegetable oils, or the thermal reaction products of methacrylate polymers with a fatty acid or alkene or alkyne containing from about 8-24 carbon atoms. The combination of a methacrylate polymer component with any of these oil components can provide either a first or second endpoint product, depending upon the reaction conditions. The term “first endpoint product” is used to describe the solubility product of the reaction which is a cooperative structure held together by many reinforcing, noncovalent interactions, including Van Der Waals attractive forces. The term “second endpoint product” is used to describe the product of the reaction which is the result of covalent bond formation between the polymer component and the oil component, as indicated by the change in molecular weight.

In a preferred embodiment, the prior art product is synthesized from an isobutyl methacrylate polymer, and the oil component is one derived from a natural oil, such as linseed oil or sunflower oil. Optionally, the composition is then diluted with a solvent, such as 2,2,4-trimethyl-1,3-pentanediol monoisobutyrate or acetone. The diluted composition can then be applied to a desired substrate for use as a filtration media.

The polymer component of the said prior absorbent composition is a synthetic polymer such as polymers derived from methacrylates. Preferably, the polymer is derived from methyl methacrylate, ethyl methacrylate, isobutyl methacrylate, or n-butyl methacrylate, or may be a copolymer containing a methacrylate polymer. Most preferably, the polymer is a poly(isobutyl methacrylate) polymer such as that obtainable from ICI Acrylics as ELVACITE® 2045, or a methacrylate/methacrylic acid copolymer such as ELVACITE® 2008 or 2043.

The test used to determine whether or not a polymer can be used in preparing the prior absorbent compositions is to combine the polymer component in question with the oil component, to see if the resultant combination forms a homogenous product after heating. Ideally, the polymer component percentage of the composition should range from about 15-75%, preferably 20-40%, or more preferably from about 25-35%, by weight.

In one embodiment of the PA absorbent composition, the oil component of the composition is a glyceride derived from oils of vegetable or animal origin. Vegetable oils are obtained by cold pressing the seeds of a plant to obtain the oil contained therein. Of the vegetable oils, drying oils such as sunflower, tung, linseed, and the like; and semi-drying oils, such as soybean and cottonseed oil, have been shown to be useful as the glyceride component. Animal oils, such as, for example, fish oil, tallow and lard can also be used as a glyceride component of the composition. It is anticipated that any drying oil or semi-drying oil will work in the composition. Generally, a drying oil is defined as a spreadable liquid that will react with oxygen to form a comparatively dry film. Optionally, combinations of two or more glycerides can be used as reactants with the polymer to provide useful absorbent compositions.

A glyceride derived from a drying oil, such as linseed oil, can be obtained from Cargill, Inc. as Supreme Linseed Oil, or sunflower oil. The glyceride should comprise from about 25-85%, preferably about 60-80%, and most preferably, from about 65-75% of the coagulant composition. All percentages in this disclosure are by weight, unless otherwise stated.

Where the oil component of the prior composition is a fatty acid or alkene or alkyne utilized as the reactant with the polymer, it contains from about 8 to 24 carbon atoms, and preferably from about 10 to 22 carbon atoms. Such fatty acids, alkenes and alkynes are commercially available from many suppliers. Typical fatty acids include both saturated and unsaturated fatty acids, such as lauric acid [dodecanoic acid], linolenic acid, cis-5-dodecanoic acid, oleic acid, erucic acid [cis-docosanoic acid], 10-undecynoic acid, stearic acid, caprylic acid, caproic acid, capric acid [decanoic acid], palmitic acid, docosanoic acid, myristoleic acid [cis-9-tetradecenoic acid], and linoleic acid. Typical alkenes and alkynes contain at least one and preferably one or two degrees of unsaturation, and from about 8 to 24 carbon atoms, with 10-20 carbon atoms being preferred. Preferred alkenes and alkynes are those such as 1-decene, trans-5-decene, trans-7-tetradecene, 1,13-tetradecadiene, 1-tetradecene, 1-decyne, and 5,7-dodecadiyne.

The said prior absorbent composition is a product with characteristics different from either of the starting materials or a simple mixture of the two starting materials, thus showing that a new composition is produced by the thermal reaction. Specifically, the oil/polymer absorbent compositions pass a clear pill test after being heated at the elevated temperatures and do not separate into two parts upon being cooled but, rather form a homogenous, uniphase compound.

The solvent can be selected from aliphatic hydrocarbons, aromatic hydrocarbons, alcohols, ketones, ethers, aldehydes, phenols, carboxylic acids, synthetic chemicals and naturally occurring substances.

The said PA absorbent composition used is prepared by a thermal reaction process. The first step of the process involves heating the oil component (glyceride or fatty acid or alkene or alkyne) to approximately 235-350° F. at a rate of about 5° F. per minute with continuous stirring. Then, the polymer component, usually in powdered form, is slowly stirred into the heated oil component. Depending upon the particular reactants used, the oil component should range from about 25-85%, preferably about 65-80%, more preferably about 72-77%, and the polymer should range from about 1-50%, preferably about 20-40%, more preferably about 23-28%, of the coagulant composition. After this mixture has been mixed properly, the mixture should be heated to approximately 400-700° F., depending on the particular components utilized for the reaction, and the desired endpoint of the reaction. Typically, reaction temperatures below about 500° F. produce “first endpoint products” while temperatures above about 500° F. produce “second endpoint products”

The mixture should be heated at that temperature until a clear pill test indicates that the reaction has reached its first end point, i.e., a drop of the reaction mixture when placed on a clear glass plate is clear. When a clear pill test indicates that the reaction has reached its first end-point, the mixture should be cooled to a temperature below 200° F., generally about 180° F. After cooling, the coagulant product can be diluted with a suitable solvent to form a more liquid product that is easier to handle and use. The temperature at which the solvent is added is not critical, but the solvent should be added at a temperature where the coagulant composition is still pliable and the solvent will not rapidly evaporate.

Two reactions appear to occur between the oil component and the polymer component based upon the temperature and time. The first endpoint of the reaction results in a rubbery viscoelastic, relatively soft product with a melting point in the range of 100° F. to 250° F. This first endpoint product is homogeneous and does not separate upon melting or dissolution. This reaction occurs at 350° F.-500° F. This is designated the “first endpoint product” (solubility product).

In the second reaction, the polymer undergoes complete or partial chain fission into discrete polymer free radicals at a temperature above about 500° F. At between 350° F. to 500° F., it is believed that partial chain fission of the polymer component (isobutylmethacrylate polymer has a m.w.=300,000 Daltons) occurs at the end of the chain or in the middle. This results in a lower molecular weight product. It is believed that there may also be a solubility reaction occurring (similar to Sn and Pb forming solder) within the ternary composition. The occurrence of a chemical reaction is confirmed, however, due to the change of molecular weight.

Reactions at above 500° F. and up to 900° F. maintained at temperature from 5 minutes to 20 hours, depending on activation energy of compositions, result in the second endpoint product. This reaction is visually observable by color, rheology, and specific heat change in the product [Note: For the first endpoint product the end of the reaction is observed by change in color and a rheology change and the cessation of solution outgassing. There is also a change in specific heat as measured by Differential Scanning Calorimetry]. The second endpoint product has a weight average molecular weight in the range of about 62,000 Daltons which is consistent with complete chain fission of the polymer, resulting in smaller free radicals which results in a lower molecular weight compound. The melting point of these products is usually above 300° F. if the oil component is highly unsaturated, which results in a solid product due to the formation of highly bonded three dimensional densely packed molecular matrix. If the oil component has a low degree of unsaturation, the resultant product is usually liquid, which is consistent with this type of reaction.

The oily component and the polymer component are reacted in a thermal reaction that does not appear to be sensitive to the atmosphere under which the reaction is carried out, i.e., whether it is an inert, oxidizing or reducing atmosphere. Absorbent compositions have been prepared by this reaction which range from soft to hard, and elastomeric to brittle in nature depending upon the ratio of the oil component to the polymer component and the choice of the polymer component and/or the oil component used. If the reaction mixture separates into two phases upon cooling it is not useful for the invention. In this manner, any polymer can be identified for use in the invention.

The mechanism of the thermal reaction remains to be elucidated. While not wishing to be bound by any theory in this regard the reaction appears to be a polymerization or phase transition reaction brought about by heat and which is stable at lower temperatures. It is hypothesized that the elevated temperatures create monomer free radicals of the polymers and copolymers which then crosslink with the unsaturated glyceride molecules. It is also hypothesized that perhaps a phase transition is occurring between the oil component and the polymer component. In an effort to determine what type of interaction or reaction is occurring between the oil component and the polymer component, thermal analysis of several of the absorbent compositions was conducted. The results indicate that a reaction is occurring between the oil component and the polymer.

Differential scanning calorimetry (DSC) was thus performed on several such compositions. DSC is a thermal analysis technique that measure the quantity of energy absorbed or evolved by a sample in calories as its temperature is changed. The sample and a reference material are heated at a programmed rate. At a transition point in the sample's heating, such as when it reaches a melting point, the sample requires more or less energy than the reference to heat. These points are indicated the typical DSC readout.

Samples were taken at the beginning of the reaction procedure described earlier and at the end of the reaction. The DSC profile for the initial starting materials is dramatically different from the profile of the product. The initial profile showed two exothermic events when the DSC analysis is carried out from 40-280° C., one event occurring at about 100° C. and the other at about 217° C. In the DSC profile of the reaction product, however, there was only one exothermic event, occurring at about 261° C. The samples were taken at initial and final points during the reaction and allowed to cool to room temperature before being subjected to the DSC.

In the instance of a further reaction, DSC's of the starting materials and final product were obtained. Again, the DSC curves generated show that two thermal events occurred for the “just mixed” reactants while only one thermal event occurred for the final product. Thus, the DSCs indicated that the occurrence of a reaction or phase transformation. Similar evidence obtained from IR spectra analysis also confirms that the absorbent compositions used in the invention are distinct products from the reactants used to prepare the absorbent compositions.

The present invention is further illustrated by the following Examples, which are indeed to be considered as merely exemplary and not delimitative of the invention otherwise described:

### EXAMPLE 1

In the first step of practicing the invention, a reaction product A of oil component and polymer is prepared as follows:

Synthesis of “Reaction Product A”:

378 g of linseed oil and 4 g of tung oil were added to a 5 liter beaker (1). The oil was mixed using a stirrer. Add 169 g of poly(isobutyl methacrylate) were added to the oil. The contents was heated to 425-450 F. while keeping the contents mixed. The resultant polymer was cooled down to about 100 F.

Preparation of Photoinitiator Mix:

85 g of HDODA (1,6 hexane diol diacrylate, monomer/crosslinking agent of UCB Specialities, Inc.) and 50 g of Darocure 1173 (2-hydroxy-2-methyl-1-phenyl-propanone photoinitiator catalyst of Ciba Specialty Chemicals) were added to 510 g of CN111 (a difunctional epoxidized soybean oil acrylate oligomer/adhesion promoter/wetting agent product of Sartomer Company) in a 5 liter beaker (2). 1800 ml of acetone were added to the mix and the mix was stirred to dissolve the contents homogenously.

Preparation of Infusion Solution

The contents of beaker (2) was added to beaker (1) and the contents were well mixed using a stirrer to create a homogenous solution of 40% active components and 60% acetone solvent.

Preparation of EB Filter Cartridges:

A 10″ Spunbond PP ((polypropylene product of Osmonics) was dipped in beaker (1) for 4 seconds. The filter was removed and drained of the excess solution for 2-3 min. The cartridge was then exposed to 360 nm wavelength D type UV lamps. The final curing of the cartridges is represented by the optimal weight increase due to crosslinking of the photoinitiator (Darocure 1173) with the monomer (HDODA, CN 111) and reaction product A. The rate of curing depends on the intensity of UV lamps used. E.g. using 600 W/sq inch intensity UV lamp @ 360 nm, curing time=5 min. Using 1 W/sq inch intensity UV lamp @ 360 nm, curing time=5 days.

### EXAMPLE 2

In this Example performance of EB filters prepared by the present invention were compared with performance of filters prepared by use of my prior art absorbent compositions.

### EB Filter Test Results

Comparative effectiveness of the treated filter material of Example 1 was evaluated as a selective oil and organic chemical filter. In the below data the filters based on the prior art compositions are designated as “PA” filters; those based on the absorbent compositions of the invention are designated as “EB filters” The identity of these filters and the procedures are as follows:

Comparative Data Between PA Cartridge and EB Cartridge:

(A) A lab test data was conducted on removal of BTEX from water:
Influent: 31 ppm BTEX which contained the following:
Benzene: 3 ppm
Toluene: 5 ppm
Ethylbenzene: 13 ppm
Xylene: 11 ppm

Effluent desired: 0.5-1.0 ppm BTEX

| | | Holding capacity before |
|---|---|---|
| Filter type | Efficiency | breakthrough at 0.5 ppm |
| 2 PA cartridges in series | 65% | Not applicable |
| 2 EB cartridges in series | >98% | 2 g |

(B) Lab test data on oil-in-water emulsions:
Influent: 50 ppm oil/water emulsion (heavy oil, light oil, surfactant)

Desired effluent: less than 15 ppm

| | | Holding capacity before |
|---|---|---|
| Filter type | Efficiency | breakthrough at 0.5 ppm |
| 2 PA cartridges in series | >99% | 1 g |
| 2 EB cartridges in series | >99% | 10 g |

The EB cartridge is able to perform at >99.9% efficiency on oil-in-water emulsions.
(C) Further tests for removal of BTEX and of chlorinated solvents such as trichloroethylene, tetrachloroethylene etc. similarly showed higher efficiency than was achieved with the PA filters. The PA cartridge performed with only between 50-70% efficiency on oil-in-water emulsions, and with BTEX and chlorinated solvents. The EB filters are clearly preferred over PA filters in these applications.

While the present invention has been set forth in terms of specific embodiments thereof, the instant disclosure is such that numerous variations upon the invention are now enabled to those skilled in the art, which variations yet reside within the scope of the present teaching. Accordingly, the invention is to be broadly construed and limited only by the scope and spirit of the claims now appended hereto.

1. A method for removing organic contaminants from an aqueous phase in which the contaminant is solubilized or emulsified, comprising:
passing said aqueous phase through a fluid-pervious filtration media which has been infused with an absorption composition comprising a solution of a homogeneous thermal reaction product of an oil component selected from the group consisting of glycerides, fatty acids, alkenes, and alkynes, and a methacrylate or acrylate polymer component; together with a photoinitiator system; said infused absorbtion composition being cured in situ at the filter by exposure to actinic radiation; and said contaminant being thereby immobilized at said media; and
collecting the purified filtrate having passed through said filtration media.

2. A method in accordance with claim 1, wherein the actinic radiation is at a UV wavelength.

3. A method in accordance with claim 2, wherein the contaminated aqueous phase is an oil/water emulsion.

4. A method in accordance with claim 2, wherein the contaminant is a BTEX contaminant.

5. A method in accordance with claim 1, wherein the contaminant is benzene.

6. A method in accordance with claim 1, wherein the contaminant is toluene.

7. A method in accordance with claim 1, wherein the contaminant is xylene.

8. A method in accordance with claim 1, wherein the contaminant is ethylbenzene.

9. A method in accordance with claim 1, wherein the contaminant is a halogenated hydrocarbon.

10. A method in accordance with claim 1, wherein the said media comprises a nonwoven polypropylene.

11. A filtration apparatus for separating organic contaminants from an aqueous phase in which the contaminant is solubilized, comprising:
a canister having an inlet and an outlet for passing said liquid phase therethrough;
a fluid-pervious media being provided at the interior of said canister in the flow path of the liquid phase proceeding between said inlet and outlet, said media being infused with an absorbtion composition comprising (1) a homogeneous thermal reaction product of an oil component selected from the group consisting of glycerides, fatty acids, alkenes, and alkynes, with a methacrylate or acrylate polymer component; component; and (2) a photoinitiator system;
said absorption composition being cured in situ at the media by exposure to actinic radiation; the said contaminant in the liquid phase flowing through said canister thereby coming into intimate contact with and being immobilized at said media.

12. A method in accordance with claim 11, wherein the actinic radiation is at a UV wavelength.

13. A method in accordance with claim 11, wherein the contaminated aqueous phase is an oil/water emulsion.

14. A method in accordance with claim 11, wherein the contaminant is a BTEX contaminant.

15. An absorption composition for infusion into and subsequent UV curing at porous filtration media of the type used for separating organic contaminants from an aqueous phase in which the contaminant is solubilized; said composition comprising:
(1) a homogeneous thermal reaction product of an oil component selected from the group consisting of glycerides, fatty acids, alkenes, and alkynes, with a methacrylate or acrylate polymer component; component; and (2) a photoinitiator system.

16. A composition in accordance with claim 15, wherein said photoinitiation system comprises a monomer cross-linking agent, a catalyst, and wetting agent.

17. A composition in accordance with claim 15, further comprising a solvent.
